(19) United States
(12) Patent Application Publication
(10) Pub. No.: US 2024/0321300 A1
(43) Pub. Date: Sep. 26, 2024

(54) MAGNETIC DISK DEVICE AND WRITE PROCESSING METHOD

(71) Applicants: Kabushiki Kaisha Toshiba, Tokyo (JP); Toshiba Electronic Devices & Storage Corporation, Tokyo (JP)

(72) Inventor: Yuki NISHIDA, Yokohama Kanagawa (JP)

(21) Appl. No.: 18/459,321

(22) Filed: Aug. 31, 2023

(30) Foreign Application Priority Data
Mar. 23, 2023 (JP) 2023-046855

(51) Int. Cl. G11B 5/55; G11B 5/31

(52) U.S. Cl. CPC G11B 5/5508; G11B 5/3146

(57) ABSTRACT

A magnetic disk device includes a disk, a head, and a control circuit. When writing data to a target range of a target track, the control circuit calculates an off-track amount based on the use information indicating use states of each of the first adjacent track and the second adjacent track, positions the head according to the calculated off-track amount, and writes data in the target range with the head positioned according to the calculated off-track amount.

### CROSS-REFERENCE TO RELATED APPLICATION(S)

This application is based upon and claims the benefit of priority from Japanese Patent Application No. 2023-046855, filed Mar. 23, 2023, the entire contents of which are incorporated herein by reference.

### FIELD

Embodiments described herein relate generally to a magnetic disk device and a write processing method.

### BACKGROUND

A magnetic disk device includes a conventional magnetic recording (CMR) type magnetic disk device in which a plurality of tracks are written at intervals in the radial direction of the disk, a shingled magnetic recording (SMR) or shingled write recording (SWR) type magnetic disk device in which a plurality of tracks are overwritten in the radial direction of the disk, and a hybrid recording type magnetic disk device that selects and executes the conventional magnetic recording type and the shingled write recording type.

### DESCRIPTION OF THE DRAWINGS

FIG. 1 is a block diagram illustrating the configuration of a magnetic disk device according to an embodiment.

FIG. 2 is a perspective view illustrating a part of the magnetic disk device and illustrates a plurality of disks and a plurality of heads.

FIG. 3 is a schematic diagram illustrating an example of arrangement of a plurality of servo regions and a plurality of data regions on a disk according to the embodiment.

FIG. 4 is a schematic diagram illustrating a part of a plurality of tracks on which conventional magnetic recording processing is performed.

FIG. 5 is a schematic diagram illustrating five tracks aligned in the radial direction and a head in the magnetic disk device, and illustrates a state in which the head is positioned to obtain a first off-track amount.

FIG. 6 is a schematic diagram illustrating the five tracks and the head, and illustrates a state in which the head is positioned to obtain a second off-track amount.

FIG. 7 is a schematic diagram illustrating the five tracks and the head, and illustrates a state in which the head is positioned to obtain a third off-track amount.

FIG. 8 is a schematic diagram illustrating the five tracks and the head, and illustrates a state in which the head is positioned to obtain a fourth off-track amount.

FIG. 9 is a schematic diagram illustrating the five tracks and the head, and illustrates a state in which the head is positioned to obtain a fifth off-track amount.

FIG. 10 is a schematic diagram illustrating the five tracks and the head, and illustrates a state in which the head is positioned without off-track.

FIGS. 11-13 depict a flowchart for a write processing method according to the embodiment.

FIG. 14 is a table illustrating the relationship between a relative track, a plurality of total values, and a swing direction according to Example 1 of the embodiment.

FIG. 15 is a table illustrating the relationship between a relative track, a plurality of total values, and a swing direction according to Example 2 of the embodiment.

FIG. 16 is a table illustrating the relationship between a relative track, a plurality of total values, and a swing direction according to Example 3 of the embodiment.

### DETAILED DESCRIPTION

Embodiments provide a magnetic disk device and a write processing method that can rewrite data efficiently.

In general, according to one embodiment, a magnetic disk device according to one embodiment includes: a disk including, on a recording layer, a target track, first and second adjacent tracks that are adjacent to the target track and are respectively on either side of the target track in a radial direction; a head configured to write data to the recording layer of the disk; and a control circuit configured to: when data is written in a target range of the target track, calculate an off-track amount based on the use information indicating use states of each of the first adjacent track and the second adjacent track, position the head according to the calculated off-track amount, and write data in the target range with the head positioned according to the calculated off-track amount.

The write processing method according to one embodiment is a write processing method applied to a magnetic disk device including: a disk including, on a recording layer, a target track, first and second adjacent tracks that are adjacent to the target track and are respectively on either side of the target track in a radial direction; and a head configured to write data to the recording layer of the disk. The write processing method includes determining use states of the first adjacent track and the second adjacent track, calculating an off-track amount based on the use states, positioning the head according to the calculated off-track amount, and writing data to a target range of the target track with the head positioned according to the calculated off-track amount.

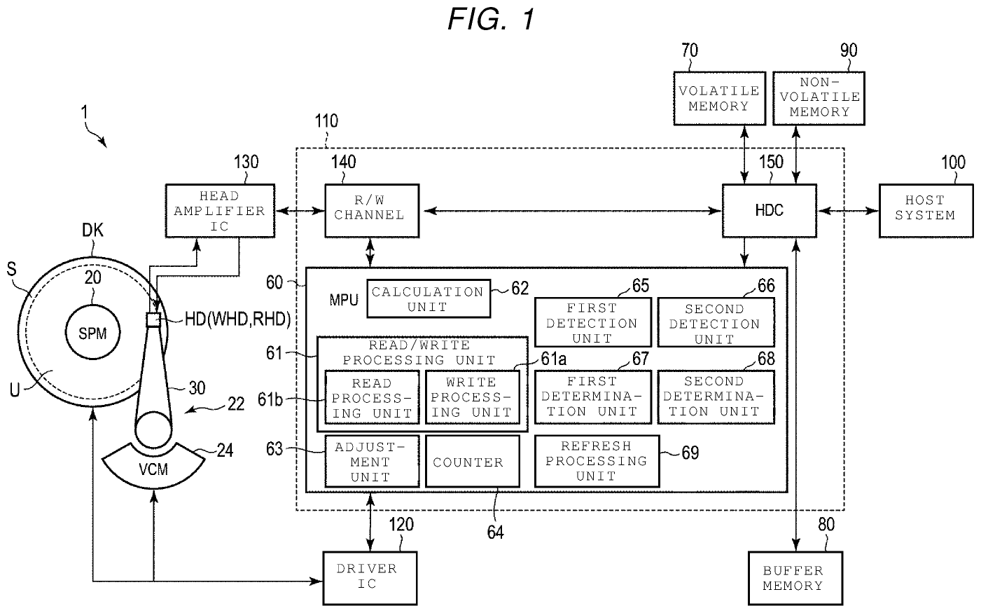

A magnetic disk device 1 and a write processing method according to an embodiment will be described in detail below with reference to the drawings. First, the configuration of the magnetic disk device 1 will be described. FIG. 1 is a block diagram illustrating the configuration of the magnetic disk device 1 according to the present embodiment. In the present embodiment, the magnetic disk device 1 is a conventional magnetic recording type magnetic disk device. However, the technique described later may be applied to a shingled write recording type magnetic disk device and a hybrid recording type magnetic disk device that selects and executes the conventional magnetic recording type or the shingled write recording type.

As illustrated in FIG. 1, the magnetic disk device 1 includes a plurality of, for example, 1 to 6 disks (magnetic disks) DK as recording media, a spindle motor (SPM) 20 as a drive motor, a head stack assembly 22, a driver IC 120, a head amplifier integrated circuit (hereinafter referred to as a head amplifier IC or preamplifier) 130, a volatile memory 70, a buffer memory (buffer) 80, a non-volatile memory 90, and a system controller 110 which is a one-chip integrated circuit. The magnetic disk device 1 is also connected to a host system (hereinafter simply referred to as host) 100.

Each disk DK is formed with a diameter of 95 mm (3.5 inches), for example, and has magnetic recording layers on both sides thereof. In the present embodiment, the magnetic disk device 1 includes 1 to 6 disks DK, but the number of disks DK is not limited thereto. Alternatively, the magnetic disk device 1 may have a single disk DK.

The head stack assembly 22 controls the movement of the head HD mounted on an arm 30 to a target position on the disk DK by driving a voice coil motor (hereinafter referred to as VCM) 24. The disk DK is divided into data writable regions: a user data region U that can be used by the user and a system region S in which information necessary for system management is written. Here, any track among a plurality of tracks of the disk DK may be defined as a target track, and a track adjacent to the target track in the radial direction of the disk DK is referred to as an adjacent track. In the target track, any sector among a plurality of sectors located in the circumferential direction of the disk DK may be set as a target sector. In the adjacent track, among the plurality of sectors located in the circumferential direction of the disk DK, the sector adjacent to the target sector in the radial direction of the disk DK is referred to as an adjacent sector.

The head HD records and reproduces information on the disk DK. The head HD has a slider as a main body, and includes a write head WHD and a read head RHD mounted on the slider. The write head WHD writes data to the recording layer of the disk DK. The read head RHD reads data from data tracks on the recording layer of the disk DK.

The driver IC 120 controls driving of the SPM 20 and the VCM 24 under the control of the system controller 110 (specifically, MPU 60 described later). The SPM 20 supports and rotates a plurality of disks DK.

The head amplifier IC 130 includes a read amplifier and a write driver. The read amplifier amplifies a read signal read from the disk DK and outputs the amplified signal to the system controller 110 (specifically, a read/write (R/W) channel 140 described later). The write driver outputs a write current corresponding to the signal output from the R/W channel 140 to the head HD.

The volatile memory 70 is a semiconductor memory that loses stored data when power is cut off. The volatile memory 70 stores data and the like necessary for processing in each unit of the magnetic disk device 1. The volatile memory 70 is, for example, a dynamic random access memory (DRAM) or a synchronous dynamic random access memory (SDRAM).

The buffer memory 80 is a semiconductor memory that temporarily records data transmitted and received between the magnetic disk device 1 and the host 100. The buffer memory 80 may be configured integrally with the volatile memory 70. The buffer memory 80 is, for example, a DRAM, a static random access memory (SRAM), SDRAM, a ferroelectric random access memory (FeRAM), a magnetoresistive random access memory (MRAM), or the like.

The non-volatile memory 90 is a semiconductor memory that retains stored data even when the power supply is cut off. The non-volatile memory 90 is, for example, a NOR-type or NAND-type flash read only memory (FROM). In the present embodiment, the non-volatile memory 90 functions as a storage unit that stores threshold values and a plurality of total values. Each total value is the sum of write count numbers corresponding to one corresponding track among a plurality of tracks on the recording layer of the disk DK. The threshold value and the plurality of total values serve as criteria for determining whether to execute a refresh process, which will be described later, and also for determining the amount of off-track.

Here, the refresh process is a process of reading track data and rewriting the data to the track. The refresh process is performed on tracks that are highly likely to cause read errors among a plurality of tracks. The above-described threshold value is set to a numerical value smaller than the number of times of writing for which reading is guaranteed.

The storage unit that stores the threshold value and the plurality of total values is not limited to the non-volatile memory 90 and may be a recording unit in the magnetic disk device 1. For example, the system region S may be used.

The system controller (controller) 110 is implemented using, for example, a large-scale integrated circuit (LSI) called system-on-a-chip (SoC) in which a plurality of elements is integrated on a single chip. The system controller 110 includes the read/write (R/W) channel 140, a hard disk controller (HDC) 150, and a microprocessor (MPU) 60. The system controller 110 is electrically connected to the driver IC 120, the head amplifier IC 130, the volatile memory 70, the buffer memory 80, the non-volatile memory 90, and the host 100.

The R/W channel 140 performs signal processing on read data transferred from the disk DK to the host 100 and write data transferred from the host 100 according to instructions from the MPU 60, which will be described later. The R/W channel 140 has a circuit that modulates the write data. The R/W channel 140 also has a circuit for measuring signal quality of the read data. The R/W channel 140 is electrically connected to, for example, the head amplifier IC 130, the HDC 150, the MPU 60, and the like.

The HDC 150 controls data transfer between the host 100 and the R/W channel 140 according to instructions from the MPU 60, which will be described later. The HDC 150 is electrically connected to, for example, the R/W channel 140, the MPU 60, the volatile memory 70, the buffer memory 80, the non-volatile memory 90, and the like.

The MPU 60 is a control circuit that controls each unit of the magnetic disk device 1 and is a main controller. The MPU 60 controls the VCM 24 via the driver IC 120 and executes servo control for positioning the head HD. The MPU 60 controls the data write operation to the disk DK and selects the storage destination of the write data transferred from the host 100. The MPU 60 also controls the data read operation from the disk DK, and controls the processing of read data transferred from the disk DK to the host 100. The MPU 60 is connected to each unit of the magnetic disk device 1. The MPU 60 is electrically connected to, for example, the driver IC 120, the R/W channel 140, the HDC 150, and the like.

The MPU 60 includes a read/write processing unit 61, a calculation unit 62, an adjustment unit 63, a counter 64, a first detection unit 65, a second detection unit 66, a first determination unit 67, a second determination unit 68, and a refresh processing unit 69. The MPU 60 executes firmware to carry out the functions of the read/write processing unit 61, the calculation unit 62, the adjustment unit 63, the counter 64, the first detection unit 65, the second detection unit 66, the first determination unit 67, the second determination unit 68, the refresh processing unit 69. Alternatively, these units may be implemented as dedicated circuits.

The read/write processing unit 61 includes a write processing unit 61a and a read processing unit 61b. According to a command from the host 100, the write processing unit 61a controls data write processing, and the read processing unit 61b controls data read processing. The read/write processing unit 61 controls the VCM 24 via the driver IC 120, positions the head HD at a target position (predetermined radial position) on the disk DK, and executes read processing or write processing.

The first detecting unit 65 can detect use information indicating the use states of the plurality of tracks on the disk DK. Here, the use information indicating the use state of the track is information indicating whether each sector of the track is a sector to which data has been written (used sector) or a sector to which no data has been written (unused sector).

The calculation unit 62 can calculate the off-track amount based on the use information. Here, the off-track amount is an amount by which the write processing unit 61a intentionally shifts the position of the head HD. Specifically, the off-track amount is the amount by which the center of the head HD deviates from the center of the target track in the radial direction of the disk DK. The write processing unit 61a can position the head HD to obtain the off-track amount, and write data in the target range of a predetermined track.

The adjustment unit 63 can adjust added values k (k1, k2, k3, and k4).

The counter 64 can count the write count number of each track located in a periphery of a predetermined track as k when data is written to the predetermined track among a plurality of tracks of the recording layer of the disk DK, and add k to each corresponding total value in the non-volatile memory 90 to update each total value. For example, when the predetermined total value just before adding k was “10” and k is “1”, the counter 64 can update the predetermined total value to “11”.

In the present embodiment, the term “periphery of a predetermined track” refers to the track that is one track adjacent (immediately adjacent) to the predetermined track and the track that is two tracks adjacent to the predetermined track. Therefore, the counter 64 of the present embodiment can count the write count number of the track immediately adjacent to the predetermined track and the write count number of the track two tracks adjacent to the predetermined track. However, the “periphery of a predetermined track” may refer only to the track that is immediately adjacent to the predetermined track. Alternatively, the “periphery of a predetermined track” may refer to a track that is immediately adjacent to the predetermined track, the track that is two tracks adjacent to the predetermined track, and the track that is three tracks adjacent to the predetermined track. Alternatively, “periphery of a predetermined track” may also refer to four or more consecutive tracks inward from the predetermined track and four or more consecutive tracks outward from the predetermined track.

The second detection unit 66 can detect a swing direction and a swing amount of the head HD when data is written in the target range of the target track. Here, the swing amount is an unintended and undesired swing amount (shift amount) of the head HD. Specifically, the swing amount is the swing amount (shift amount) of the center of the head HD in the radial direction of the disk DK from the position determined by the write processing unit 61a.

The first determination unit 67 can determine to which side of the adjacent tracks on both sides of the target track the head HD swung last time based on the plurality of total values stored in the non-volatile memory 90 and the swing direction detected by the second detection unit 66 when data was written to the target track last time. For example, the first determination unit 67 can determine whether the head HD swung toward the adjacent track having the larger total value among adjacent tracks on both sides. The second determination unit 68 can determine whether the total value corresponding to the adjacent tracks exceeds a threshold value.

The refresh processing unit 69 can read the data of the adjacent track having a total value exceeding the threshold value, rewrite the data to the adjacent track to refresh the adjacent track, and reset the total value in the non-volatile memory 90 corresponding to the adjacent track.

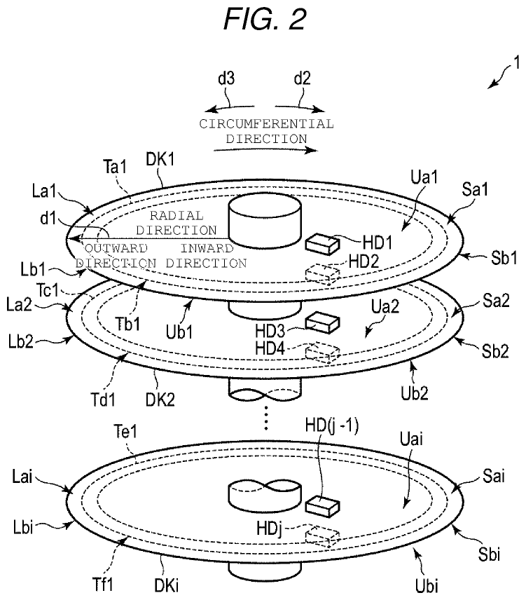

FIG. 2 is a perspective view illustrating a part of the magnetic disk device 1 and illustrates a plurality of disks DK and a plurality of heads HD. As illustrated in FIG. 2, the direction in which the disk DK rotates in the circumferential direction is referred to as a rotation direction d3. In the example illustrated in FIG. 2, the rotation direction is illustrated as counterclockwise, but the rotation direction may be reversed (clockwise). A traveling direction d2 of the head HD with respect to the disk DK is opposite to the rotation direction d3. The traveling direction d2 is the direction in which the head HD sequentially writes and reads data to and from the disk DK in the circumferential direction, that is, the direction in which the head HD moves relative to the disk DK in the circumferential direction.

The magnetic disk device 1 includes i disks DK1 to DKi, and j heads HD1 to HDj. In the present embodiment, the number of heads HD is twice the number of disks DK (j=2xi). The disks DK1 to DKi are located coaxially and stacked on top of each other at intervals. The diameters of the disks DK1 to DKi are the same. Here, terms such as “same”, “identical”, “match”, and “equivalent” include not only exactly the same but also different enough to be regarded as substantially the same. Alternatively, the diameters of the disks DK1 to DKi may differ from each other.

Each disk DK includes a recording layer L on both sides. For example, the disk DK1 includes a first recording layer La1 and a second recording layer Lb1 on the opposite side of the first recording layer La1. The disk DK2 includes a first recording layer La2 and a second recording layer Lb2 on the opposite side of the first recording layer La2. The disk DKi includes a first recording layer Lai and a second recording layer Lbi on the opposite side of the first recording layer Lai. Each first recording layer La may also be referred to as a front surface or recording surface. Each second recording layer Lb may also be referred to as a back surface or a recording surface.

As described above, the magnetic disk device 1 of the present embodiment is a conventional magnetic recording type magnetic disk device. Therefore, the user data region U of each recording layer L is a conventional magnetic recording region. In a conventional magnetic recording type magnetic disk device, random data writing in the user data region U is permitted.

Each recording layer L has a user data region U and a system region S. The first recording layer La1 has a user data region Ua1 and a system region Sa1. The second recording layer Lb1 has a user data region Ub1 and a system region Sb1. The first recording layer La2 has a user data region Ua2 and a system region Sa2. The second recording layer Lb2 has a user data region Ub2 and a system region Sb2. The first recording layer Lai has a user data region Uai and a system region Sai. The second recording layer Lbi has a user data region Ubi and a system region Sbi.

In the user data region Ua1 on the first recording layer La1, a track sandwiched between double dashed lines in the drawing is called a track Ta1. In the user data region Ub1 on the second recording layer Lb1, the track located on the opposite side of the track Ta1 is called a track Tb1. In the user data region Ua2 on the first recording layer La2, a track sandwiched between double dashed lines in the drawing is called a track Tc1. In the user data region Ub2 on the second recording layer Lb2, the track located on the opposite side of the track Tc1 is called a track Td1. In the user data region Uai on the first recording layer Lai, a track sandwiched between double dashed lines in the drawing is called track Tel. In the user data region Ubi on the second recording layer Lbi, the track located on the opposite side of the track Tel is called a track Tf1. In the present embodiment, the tracks Ta1, Tb1, Tc1, Td1, Tel, and Tf1 are located in the same cylinder.

The head HD faces the disk DK. In the present embodiment, one head HD faces each recording layer L of the disk DK. For example, the head HD1 faces the first recording layer La1 of the disk DK1, writes data to the first recording layer La1, and reads data from the first recording layer La1. The head HD2 faces the second recording layer Lb1 of the disk DK1, writes data to the second recording layer Lb1, and reads data from the second recording layer Lb1. The head HD3 faces the first recording layer La2 of the disk DK2, writes data to the first recording layer La2, and reads data from the first recording layer La2. The head HD4 faces the second recording layer Lb2 of the disk DK2, writes data to the second recording layer Lb2, and reads data from the second recording layer Lb2. The head HDj−1 faces the first recording layer Lai of the disk DKi, writes data to the first recording layer Lai, and reads data from the first recording layer Lai. The head HDj faces the second recording layer Lbi of the disk DKi, writes data to the second recording layer Lbi, and reads data from the second recording layer Lbi.

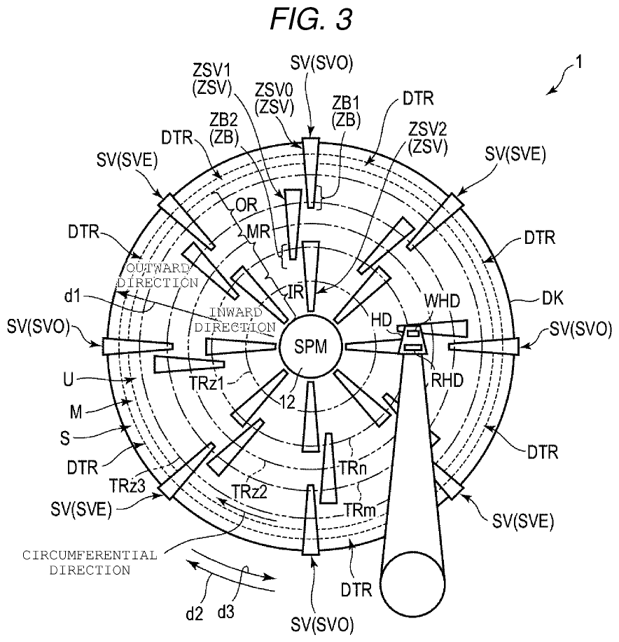

FIG. 3 is a schematic diagram illustrating an example of arrangement of a plurality of servo regions SV and a plurality of data regions DTR on the disk DK according to the embodiment. As illustrated in FIG. 3, in the radial direction d1 of the disk DK, the direction toward the outer circumference of the disk DK is called an outward direction (outer side), and the direction opposite to the outward direction is called an inward direction (inner side). In FIG. 3, the user data region U is divided into an inner circumferential region IR positioned inward, an outer circumferential region OR positioned outward, and a middle circumferential region MR positioned between the inner circumferential region IR and the outer circumferential region OR.

The disk DK has a plurality of servo regions SV and a plurality of data regions DTR. The plurality of servo regions SV may, for example, radially extend in the radial direction of the disk DK and be discretely located at predetermined intervals in the circumferential direction. The plurality of servo regions SV may, for example, linearly extend from the inner circumference to the outer circumference and be discretely located at predetermined intervals in the circumferential direction. The plurality of servo regions SV may, for example, spirally extend from the inner circumference to the outer circumference and be discretely located at predetermined intervals in the circumferential direction. The plurality of servo regions SV may be located in islands in the radial direction, and may be located discretely at different predetermined intervals in the circumferential direction. Hereinafter, one servo region SV in a predetermined track may be referred to as a “servo sector”. The “servo region SV” may also be referred to as a “servo sector” The servo sector contains servo data. Hereinafter, “arrangement or the like of some servo data that make up a servo sector” may be referred to as a “servo pattern”. “Servo data written in a servo sector” may also be referred to as a “servo sector”.

The plurality of data regions DTR are located between the plurality of servo regions SV. For example, the data region DTR corresponds to a region between two successive servo regions SV in the circumferential direction. Hereinafter, one data region DTR in a predetermined track may be referred to as a “data sector”. The “data region DTR” may be referred to as a “data sector DTR”. A data sector contains user data. “User data written to data sector” may be referred to as a “data sector”. The “data sector” may be referred to as a “user data”. A “pattern including several pieces of data” may be referred to as a “data pattern”. In the example illustrated in FIG. 2, the data pattern of a predetermined track includes servo data (or servo sectors) and user data (or data sectors).

The servo region SV has a plurality of zone servo regions ZSV and the like. In addition to the zone servo region ZSV, the servo region SV may include a region including a gap (circumferential positional deviation between two zone servo regions), a region including servo data, the data region DTR, and the like. A plurality of zone servo regions ZSV are located discretely along the radial direction. The plurality of zone servo regions ZSV each extend radially.

One zone servo region ZSV in a predetermined track may be referred to as a “zone servo sector” or a “servo sector”. The “zone servo region ZSV” may be referred to as a “zone servo sector ZSV” or “servo sector ZSV”. “Servo data written in a zone servo sector” may be referred to as a “zone servo sector” or a “servo sector”. Hereinafter, “arrangement of servo data that make up a zone servo sector” may be referred to as a “zone servo pattern” or “servo pattern”. Hereinafter, one servo region SV in a predetermined track may be referred to as a “zone pattern sector”.

The “servo region SV” may be referred to as a “zone pattern sector”. “At least one piece of data and the like written to the zone pattern sector” may be referred to as a “zone pattern sector”. A zone pattern sector includes at least one zone servo sector. Hereinafter, the “data pattern of the zone pattern sector” may be referred to as the “zone data pattern”.

In the example illustrated in FIG. 3, the servo region SV includes zone servo regions ZSV0, ZSV1, and ZSV2. The zone servo regions ZSV0, ZSV1, and ZSV2 are arranged in a staggered pattern in the radial direction. The zone servo regions ZSV0, ZSV1, and ZSV2 may be arranged in a staircase pattern in radial direction.

The zone servo region ZSV2 is positioned further inward than the zone servo region ZSV1. The zone servo region ZSV0 is positioned further outward than the zone servo region ZSV1. For example, the zone servo region ZSV2 is located from the center of the disk DK to the middle circumferential region MR, the zone servo region ZSV1 is located from the inner circumferential region IR to the outer circumferential region OR, and the zone servo region ZSV0 is located from the middle circumferential region MR to the outer edge of the disk DK. Hereinafter, in a predetermined servo region SV, a predetermined region in the radial direction in which a plurality of zone servo regions ZSV are located in the circumferential direction may be referred to as a zone servo boundary region, a double servo region, or a double zone servo region ZB.

In the example illustrated in FIG. 2, main servo regions SVO and secondary servo regions SVE are alternately located at intervals in the circumferential direction. For example, one secondary servo region SVE is located between two main servo regions SVO that are successively located at an interval in the circumferential direction. For example, if all the servo regions SV of the disk DK are given consecutive numbers, the main servo region SVO corresponds to the odd-numbered servo regions SV, and the secondary servo region SVE corresponds to the even-numbered servo regions SV. In some implementations, two or more secondary servo regions SVE may be located between two main servo regions SVO that are successively located at an interval in the circumferential direction.

The main servo region SVO and the secondary servo region SVE may include, for example, only servo regions for reading and demodulating servo data as a whole (hereinafter sometimes referred to as normal servo regions). Hereinafter, “reading and demodulating servo data” may be referred to as a “servo reading”. The main servo region SVO and the secondary servo region SVE may include, for example, normal servo regions and servo regions for servo-reading a circumferential range of servo data that is smaller than the circumferential range of the servo data to be servo-read in the normal servo regions (hereinafter sometimes referred to as short servo regions).

A media cache M is allocated on the disk DK. However, the media cache M is optional and may not be allocated on the disk DK. By using the plurality of servo data described above, it is possible to position the head HD to obtain a predetermined amount of off-track, and to detect the swing amount and the swing direction of the head HD.

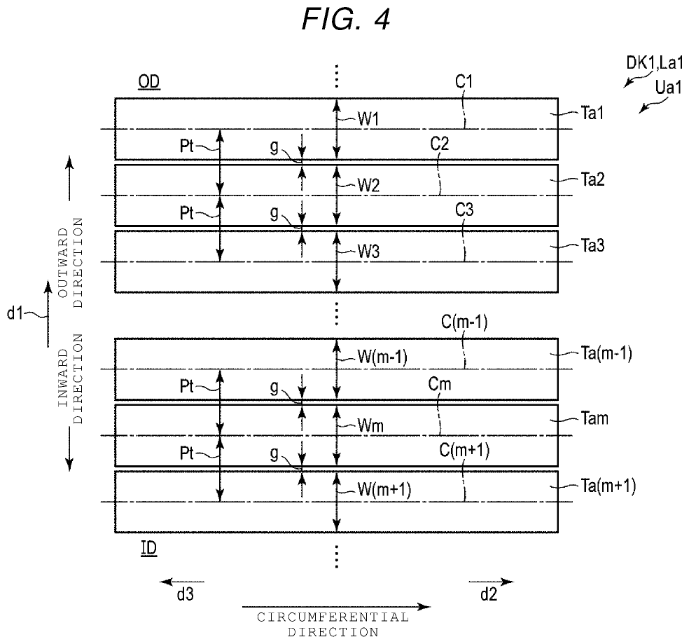

FIG. 4 is a schematic diagram illustrating a part of a plurality of tracks on which conventional magnetic recording processing is performed. As illustrated in FIG. 4, the first recording layer La1 of the disk DK1 includes tracks Ta1, Ta2, Ta3, . . . , Ta(m−1), Tam, Ta(m+1), and the like located in the radial direction d1. In the drawing, the track Ta1 is located on the outermost OD side of the disk DK1, and the track Ta(m+1) is located on the innermost ID side of the disk DK1.

The track Ta1 has a track width W1 in the radial direction d1 and a track center C1 at the center in the radial direction d1. Like the track Ta1, the track Ta2 has a track width W2 and a track center C2, the track Ta3 has a track width W3 and a track center C3, the track Ta(m−1) has a track width W(m−1) and a track center C(m−1), the track Tam has a track width Wm and a track center Cm, and the track Ta(m+1) has a track width W(m+1) and a track center C(m+1). The track widths W1 to W(m+1) are the same. However, the track widths W1 to W(m+1) may be different from each other.

The tracks Ta1 to Ta(m+1) are located at a pitch (e.g., conventional magnetic recording track pitch) Pt in the radial direction d1. For example, the track center C1 and the track center C2 are separated by a pitch Pt in the radial direction d1, and the track center C2 and the track center C3 are separated by the pitch Pt in the radial direction d1. The track center C(m−1) and the track center Cm are separated by the pitch Pt in the radial direction d1, and the track center Cm and the track center C(m+1) are separated by the pitch Pt in the radial direction d1. The tracks Ta1 to Ta(m+1) may be located at different pitches in the radial direction d1.

In a conventional magnetic recording type magnetic disk device, it is possible to increase the density by designing the pitch Pt to be narrow to increase the storage capacity.

In the example illustrated in FIG. 4, the tracks Ta1 to Ta(m+1) are located with a gap g in the radial direction d1. For example, the tracks Ta1 and Ta2 are separated by the gap g in the radial direction d1, and the tracks Ta2 and Ta3 are separated by the gap g in the radial direction d1. The tracks Ta(m−1) and Tam are separated by the gap g in the radial direction d1, and the tracks Tam and Ta(m+1) are separated by the gap g in the radial direction d1. The tracks Ta1 to Ta(m+1) may be located with different gaps therebetween.

In FIG. 4, each track Ta is illustrated in a rectangular shape for convenience of description, but actually each track Ta is curved along the circumferential direction. Each track may have a wavy shape extending in the circumferential direction while fluctuating in the radial direction d1.

When performing normal write processing, the write processing unit 61a positions the head HD1 at the track center C1 to write data to the track Ta1, positions the head HD1 at the track center C2 to write data to the track Ta2, positions the head HD1 at the track center C3 to write data to the track Ta3, positions the head HD1 at the track center C(m−1) to write the data to the track Ta(m−1), positions the head HD1 at the track center Cm to write data to the track Tam, and positions the head HD1 at the track center C(m+1) to write the data to the track Ta(m+1).

In the example illustrated in FIG. 4, the write processing unit 61a may sequentially execute write processing on the tracks Ta1 to Ta(m+1), or randomly execute write processing on predetermined sectors on each of the tracks Ta1 to Ta(m+1). The magnetic disk device 1 of the embodiment is configured as described above.

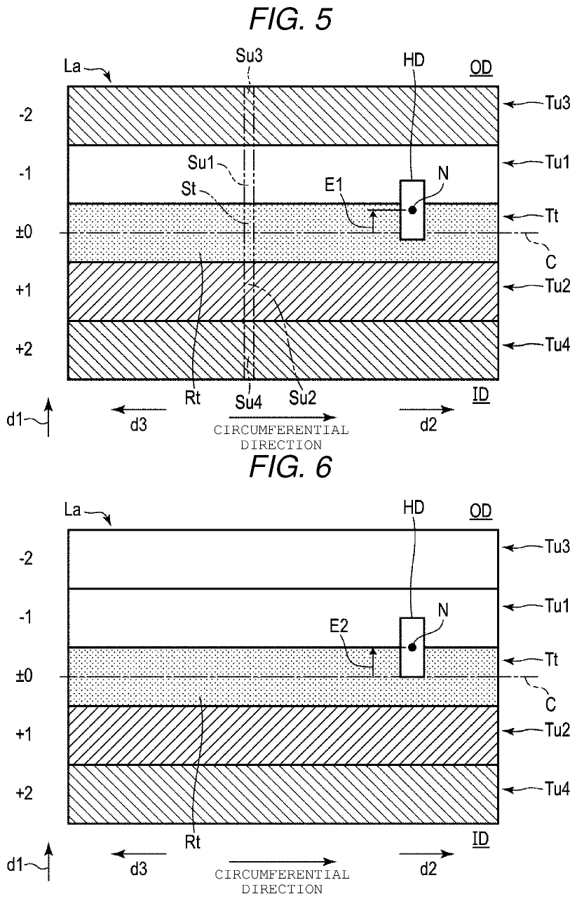

Next, a write processing method applied to the magnetic disk device 1 will be described. FIG. 5 is a schematic diagram illustrating five tracks T aligned in the radial direction and the head HD in the magnetic disk device 1 and illustrates a state in which the head HD is positioned to obtain a first off-track amount E1. For convenience of description, each track T is illustrated in a rectangular shape in FIG. 5 and subsequent drawings as in FIG. 4.

As illustrated in FIG. 5, the disk DK includes a target track Tt, a first adjacent track Tu1, a second adjacent track Tu2, a third adjacent track Tu3, and a fourth adjacent track Tu4 on the recording layer La. The target track Tt includes a target range Rt having one or more sectors. In the example illustrated in FIG. 5, the entire target track Tt is the target range Rt. The target track Tt (and the target range Rt) has a plurality of sectors such as a sector St.

The first adjacent track Tu1 is adjacent to the target track Tt in the radial direction d1. The first adjacent track Tu1 has a plurality of sectors such as a sector Su1 adjacent to the sector St in the radial direction d1. In the present embodiment, the first adjacent track Tu1 is located on the outer circumference OD side of the target track Tt.

The second adjacent track Tu2 is adjacent to the target track Tt in the radial direction d1. The second adjacent track Tu2 has a plurality of sectors such as a sector Su2 adjacent to the sector St in the radial direction d1. The second adjacent track Tu2 sandwiches the target track Tt together with the first adjacent track Tu1 in the radial direction d1. In the present embodiment, the second adjacent track Tu2 is located on the inner circumference ID side of the target track Tt.

The third adjacent track Tu3 is adjacent to the first adjacent track Tu1 in the radial direction d1. The third adjacent track Tu3 has a plurality of sectors such as a sector Su3 adjacent to the sector Su1 in the radial direction d1. The third adjacent track Tu3 sandwiches the first adjacent track Tu1 together with the target track Tt in the radial direction d1. In the present embodiment, the third adjacent track Tu3 is located on the outer circumference OD side of the first adjacent track Tu1.

The fourth adjacent track Tu4 is adjacent to the second adjacent track Tu2 in the radial direction d1. The fourth adjacent track Tu4 has a plurality of sectors such as a sector Su4 adjacent to the sector Su2 in the radial direction d1. The fourth adjacent track Tu4 sandwiches the second adjacent track Tu2 together with the target track Tt in the radial direction d1. In the present embodiment, the fourth adjacent track Tu4 is located on the inner circumference ID side of the second adjacent track Tu2.

Here, the target track Tt is set to “±0”. The outer circumference OD side of the disk DK is set to be negative, and “1” is subtracted each time one track advances toward the outer circumference OD side. The inner circumference ID side of the disk DK is set to be positive, and “1” is added each time one track advances toward the inner circumference ID side. If a plurality of tracks T are indicated relatively, the third adjacent track Tu3 is “−2” the first adjacent track Tu1 is “−1”, the second adjacent track Tu2 is “+1”, and the fourth adjacent track Tu4 is “+2”.

In FIG. 5, the target range Rt to which data is to be written is marked with a dot pattern, unused sectors are blank, and used sectors are marked with right upward or right downward diagonal lines. Hereinafter, a sector means a sector in the data region DTR in FIG. 3 and does not mean a sector in the servo region SV.

As illustrated in FIGS. 5 and 1, when data is written in the target range Rt of the target track Tt, the first detection unit 65 detects use information that indicates the use states of the first adjacent track Tu1 and the second adjacent track Tu2. Subsequently, the calculation unit 62 calculates the off-track amount based on the use information. After that, the write processing unit 61a positions the head HD to obtain the off-track amount, and writes the data in the target range Rt.

The first detection unit 65 detects use information indicating the respective use states of the first adjacent track Tu1, the second adjacent track Tu2, the third adjacent track Tu3, and the fourth adjacent track Tu4. In FIG. 5, the entire first adjacent track Tu1 is unused, the entire second adjacent track Tu2 is used, and the entire third adjacent track Tu3 is used. The entire fourth adjacent track Tu4 is used. Although in FIG. 5, the second adjacent track Tu2 to the fourth adjacent track Tu4 are illustrated as an example of the use state, in the example of obtaining the first off-track amount E1 in FIG. 5, the second adjacent track Tu2 need only be at least partially used, the third adjacent track Tu3 need only be at least partially used, and the fourth adjacent track Tu4 may be in any use state.

Here, the use information detected by the first detection unit 65 is first use information that indicates that the first adjacent track Tu1 is entirely unused, the second adjacent track Tu2 contains used sectors, and the third adjacent track Tu3 contains used sectors.

When the first detection unit 65 detects the first use information and writes data in the target range Rt of the target track Tt, the calculation unit 62 calculates the first off-track amount E1, which is the deviation amount of the center N of the head HD from the center of the target track Tt (track center C) toward the first adjacent track Tu1 based on the first use information. Next, the write processing unit 61a positions the head HD to obtain the first off-track amount E1, and writes the data in the target range Rt. In the radial direction d1, the first off-track amount E1 corresponds to the distance from the center of the target track Tt (track center C) to the center N of the head HD.

When writing with the first off-track amount E1, influence of adjacent track interference (ATI) on the first adjacent track Tu1 and the third adjacent track Tu3 becomes larger compared to the case where the center N of the head HD is positioned at the center of the target track Tt (track center C), but the influence of ATI on the second adjacent track Tu2 and the fourth adjacent track Tu4 becomes smaller.

The write count numbers of each of the second adjacent track Tu2 and the fourth adjacent track Tu4 can be made smaller than the above k by the first off-track amount E1. For example, when k=1, the write count numbers of the second adjacent track Tu2 and the fourth adjacent track Tu4 are counted as less than “1”. Compared to the case where the write count number of each of the second adjacent track Tu2 and the fourth adjacent track Tu4 is counted as “1” each time, the frequency of performing the refresh process on the second adjacent track Tu2 and the fourth adjacent track Tu4 can be reduced. As a result, since the frequency of performing the refresh process on the disk DK can be reduced, the performance of the magnetic disk device 1 can be improved.

FIG. 6 is a schematic diagram illustrating five tracks T and the head HD and illustrates a state in which the head HD is positioned to obtain a second off-track amount E2. In FIG. 6, the target range Rt to which data is to be written is marked with a dot pattern, unused sectors are blank, and used sectors are marked with right upward or right downward diagonal lines.

As illustrated in FIGS. 6 and 1, the entire first adjacent track Tu1 is unused, the entire second adjacent track Tu2 is used, and the entire third adjacent track Tu3 is unused. The entire fourth adjacent track Tu4 is used. Although in FIG. 6, the second adjacent track Tu2 and the fourth adjacent track Tu4 are illustrated as an example of the use state, in the example of obtaining the second off-track amount E2 in FIG. 6, at least a part of the second adjacent track Tu2 needs to be used, and the use state of the fourth adjacent track Tu4 does not matter. Here, the use information detected by the first detection unit 65 is second use information indicating that the entire first adjacent track Tu1 is unused, the entire third adjacent track Tu3 is unused, and the second adjacent track Tu2 contains used sectors.

When the first detection unit 65 detects the second use information and writes data in the target range Rt of the target track Tt, the calculation unit 62 calculates the second off-track amount E2, which is the amount of deviating the center N of the head HD from the center of the target track Tt (track center C) toward the first adjacent track Tu1 based on the second use information. Next, the write processing unit 61a positions the head HD to obtain the second off-track amount E2 and writes the data in the target range Rt.

The second off-track amount E2 is greater than the first off-track amount E1 (E2>E1). The write count numbers of each of the second adjacent track Tu2 and the fourth adjacent track Tu4 can be made further smaller by the second off-track amount E2. The frequency of performing the refresh process on the disk DK can be further reduced.

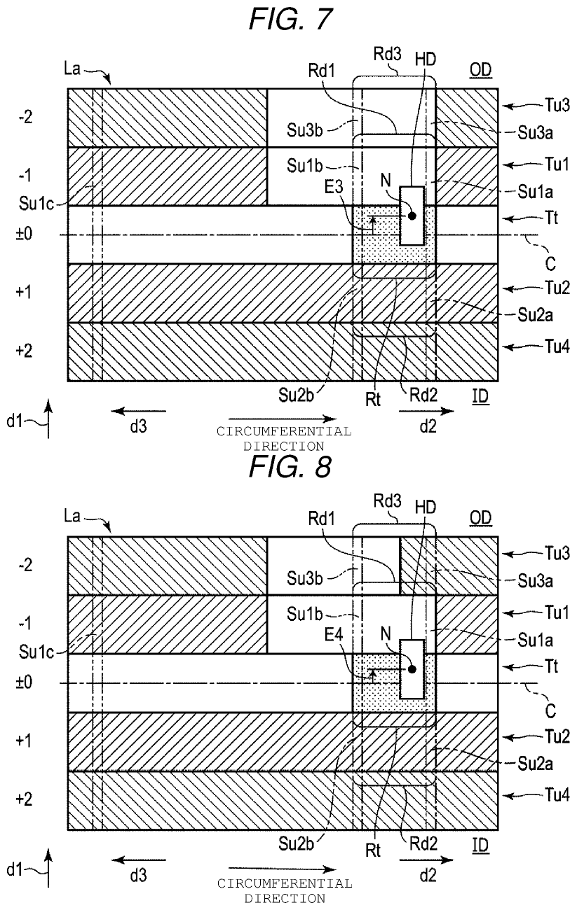

FIG. 7 is a schematic diagram illustrating five tracks T and the head HD and illustrates a state in which the head HD is positioned to obtain a third off-track amount E3. In FIG. 7, the target range Rt to which data is to be written is marked with a dot pattern, unused sectors are blank, and used sectors are marked with right upward or right downward diagonal lines.

As illustrated in FIG. 7, the target track Tt has the target range Rt. In the example illustrated in FIG. 7, the target range Rt is part of the target track Tt and includes one or more sectors. The first adjacent track Tu1 includes a first adjacent region Rd1 with all sectors adjacent to the target range Rt in the radial direction d1. The second adjacent track Tu2 includes a second adjacent region Rd2 with all sectors adjacent to the target region Rt in the radial direction d1. The third adjacent track Tu3 includes a third adjacent region Rd3 with all sectors adjacent to the first adjacent region Rd1 in the radial direction d1.

In the first adjacent track Tu1, all sectors at least in the first adjacent range Rd1, such as the sectors Su1a and Su1b, are unused. The first adjacent track Tu1 includes used sectors other than the first adjacent range Rd1, such as the sector Su1c. In the second adjacent track Tu2, all sectors at least in the second adjacent range Rd2, such as the sectors Su2a and Su2b are used. In the third adjacent track Tu3, all sectors at least in the third adjacent range Rd3, such as the sectors Su3a and Su3b are unused. The entire fourth adjacent track Tu4 is used. Although in FIG. 7, the second adjacent track Tu2 and the fourth adjacent track Tu4 are illustrated as an example of the use state, in the example of obtaining the third off-track amount E3 in FIG. 7, at least a part of the second adjacent range Rd2 of the second adjacent track Tu2 needs to be used, and the use state of the fourth adjacent track Tu4 does not matter.

In the above case, the use information detected by the first detection unit 65 is third use information indicating that all sectors in the first adjacent range Rd1 are unused, the first adjacent track Tu1 contains used sectors other than in the first adjacent range Rd1, all sectors in the third adjacent range Rd3 are unused, and the second adjacent range Rd2 contains used sectors.

As illustrated in FIGS. 7 and 1, when the first detection unit 65 detects the third use information and writes data in the target range Rt of the target track Tt, the calculation unit 62 calculates the third off-track amount E3, which is the amount of deviating the center N of the head HD from the center of the target track Tt (track center C) toward the first adjacent track Tu1 based on the third use information. Next, the write processing unit 61a positions the head HD to obtain the third off-track amount E3, and writes the data in the target range Rt.

The third off-track amount E3 is less than or equal to the first off-track amount E1 (E1≥E3). Here, since the write count numbers of each of the second adjacent track Tu2 and the fourth adjacent track Tu4 can be reduced, the frequency of performing the refresh process of the disk DK can be reduced.

FIG. 8 is a schematic diagram illustrating five tracks T and the head HD and illustrates a state in which the head HD is positioned to obtain a fourth off-track amount E4. In FIG. 8, the target range Rt to which data is to be written is marked with a dot pattern, unused sectors are blank, and used sectors are marked with right upward or right downward diagonal lines.

As illustrated in FIG. 8, in the first adjacent track Tu1, all sectors at least in the first adjacent range Rd1, such as the sectors Su1a and Su1b are unused. The first adjacent track Tu1 includes used sectors other than the first adjacent range Rd1, such as the sector Su1c. In the second adjacent track Tu2, all sectors at least in the second adjacent range Rd2, such as the sectors Su2a and Su2b are used. The third adjacent track Tu3 includes some used sectors at least in the third adjacent range Rd3, such as a sector Su3a. A sector Su3b in the third adjacent range Rd3 is unused. The entire fourth adjacent track Tu4 is used. Although in FIG. 8, the second adjacent track Tu2 and the fourth adjacent track Tu4 are illustrated as an example of the use state, in the example of obtaining the fourth off-track amount E4 in FIG. 8, it is sufficient that at least a part of the second adjacent range Rd2 of the second adjacent track Tu2 is used, and the use state of the fourth adjacent track Tu4 does not matter.

In the above case, the use information detected by the first detection unit 65 is fourth use information indicating that all sectors in the first adjacent range Rd1 are unused, the first adjacent track Tu1 contains used sectors other than in the first adjacent range Rd1, the third adjacent range Rd3 contains used sectors, and the second adjacent range Rd2 contains used sectors.

As illustrated in FIGS. 8 and 1, when the first detection unit 65 detects the fourth use information and writes data in the target range Rt of the target track Tt, the calculation unit 62 calculates the fourth off-track amount E4, which is the amount of deviating the center N of the head HD from the center of the target track Tt (track center C) toward the first adjacent track Tu1 based on the fourth use information. Next, the write processing unit 61a positions the head HD to obtain the fourth off-track amount E4, and writes the data in the target range Rt.

The fourth off-track amount E4 is less than the third off-track amount E3 (E3>E4). Here, since the write count numbers of each of the second adjacent track Tu2 and the fourth adjacent track Tu4 can be reduced, the frequency of performing the refresh process of the disk DK can be reduced.

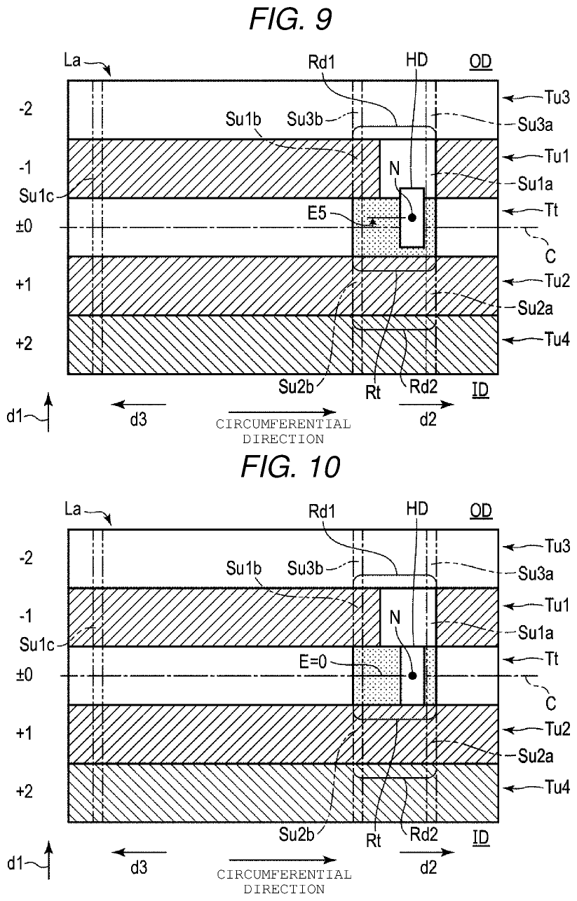

FIG. 9 is a schematic diagram illustrating five tracks T and the head HD and illustrates a state in which the head HD is positioned to obtain a fifth off-track amount E5. In FIG. 9, the target range Rt to which data is to be written is marked with a dot pattern, unused sectors are blank, and used sectors are marked with right upward or right downward diagonal lines.

As illustrated in FIG. 9, the first adjacent track Tu1 includes some used sectors at least in the first adjacent range Rd1, such as the sector Su1b. The sector Su1a in first adjacent range Rd1 is unused. The first adjacent track Tu1 includes used sectors other than the first adjacent range Rd1, such as the sector Su1c. In the second adjacent track Tu2, all sectors at least in the second adjacent range Rd2, such as the sectors Su2a and Su2b are used. The entire third adjacent track Tu3, such as the sectors Su3a and Su3b, is unused. The entire fourth adjacent track Tu4 is used. Although in FIG. 9, the second adjacent track Tu2 to the fourth adjacent track Tu4 are illustrated as an example of the use state, in the example of obtaining the fifth off-track amount E5 in FIG. 9, at least a part of the second adjacent range Rd2 of the second adjacent track Tu2 needs to be used, the use state of the third adjacent track Tu3 does not matter, and the use state of the fourth adjacent track Tu4 does not matter.

In the above case, the use information detected by the first detecting unit 65 is fifth use information indicating that the first adjacent range Rd1 contains used sectors and the second adjacent range Rd2 contains used sectors.

As illustrated in FIGS. 9 and 1, when the first detection unit 65 detects the fifth use information and data is written in the target range Rt of the target track Tt, the first determination unit 67 determines to which side of the first adjacent track Tu1 and the second adjacent track Tu2 the head HD should swing, based on a plurality of total values stored in the non-volatile memory 90 and the swing direction detected by the second detection unit 66 when data was written to the target track Tt last time. When writing data to the target track Tt for the first time, the first determination unit 67 does not determine the swing direction. Here, the write processing unit 61a can perform a normal write (writing data in the target range Rt so that the off-track amount E becomes 0).

For example, when the center N of the head HD is positioned at the center of the target track Tt (track center C) and data is written to the target track Tt, when the center N of the head HD swung toward the second adjacent track Tu2 side of the track center C, the second detection unit 66 can determine that the head HD swung toward the second adjacent track Tu2 based on the location information of the head HD. The location information (in particular, swing information) of the head HD can be obtained by reading the servo data of the servo region SV with the read head RHD.

Here, it is assumed that the total value corresponding to the second adjacent track Tu2 is greater than the total value corresponding to the first adjacent track Tu1. When the first determination unit 67 determines that the head HD swung toward the second adjacent track Tu2 having a larger total value, the second determination unit 68 determines whether the total value corresponding to the second adjacent track Tu2 exceeds the threshold value.

When the total value does not exceed the threshold value, the calculation unit 62 calculates the fifth off-track amount E5, which is the amount by which the center N of the head HD is shifted from the center of the target track Tt (track center C) to the side of the first adjacent track Tu1 with smaller total value based on the swing amount detected by the second detection unit 66. After that, the write processing unit 61a positions the head HD to obtain the fifth off-track amount E5, and writes the data in the target range Rt.

Here, it is assumed that h is a coefficient and Q is the swing amount of the head HD, where 0≤h≤1.0. Then, the fifth off-track amount E5 can be obtained by the following Equation 1:

E5=h×Q (Equation 1)

The fifth off-track amount E5 is less than the fourth off-track amount E4 (E4>E5). Here, since the write count numbers of each of the second adjacent track Tu2 and the fourth adjacent track Tu4 can be reduced, the frequency of performing the refresh process of the disk DK can be reduced.

FIG. 10 is a schematic diagram illustrating the five tracks T and the head HD and illustrates a state in which the head HD is positioned without off-track. The use state of the five tracks T in FIG. 10 is the same as the use state of the five tracks T in FIG. 9.

First, the case where the head HD has not swung toward the side of the second adjacent track Tu2 having a larger total value when data was written to the target track Tt last time will be described. As illustrated in FIGS. 10 and 1, when the first determination unit 67 determines that the head HD did not swing toward the side of the second adjacent track Tu2 having a larger total value, the second determination unit 68 does not determine whether the total value exceeds the threshold value, the calculation unit 62 does not calculate the off-track amount, and the write processing unit 61a positions the head HD so that the center N of the head HD matches the center of the target track Tt (track center C), and writes data in the target range Rt. Since the off-track amount E is 0, the write processing unit 61a can normally write data to the target range Rt.

Next, the case where the total value corresponding to the second adjacent track Tu2 exceeds the threshold will be described. As illustrated in FIGS. 10 and 1, when the second determination unit 68 determines that the total value corresponding to the second adjacent track Tu2 exceeds the threshold value, the calculation unit 62 does not calculate the off-track amount, the refresh processing unit 69 reads the data of the second adjacent track Tu2 (hereinafter, also referred to as data of interest), rewrites the data of interest to the second adjacent track Tu2 to refresh the second adjacent track Tu2, and resets the total value in the non-volatile memory 90 corresponding to the second adjacent track Tu2, and the write processing unit 61a positions the head HD so that the center N of the head HD matches the center of the target track Tt (track center C), and writes data in the target range Rt. Here, since the off-track amount E is 0, the write processing unit 61a can normally write data to the target range Rt.

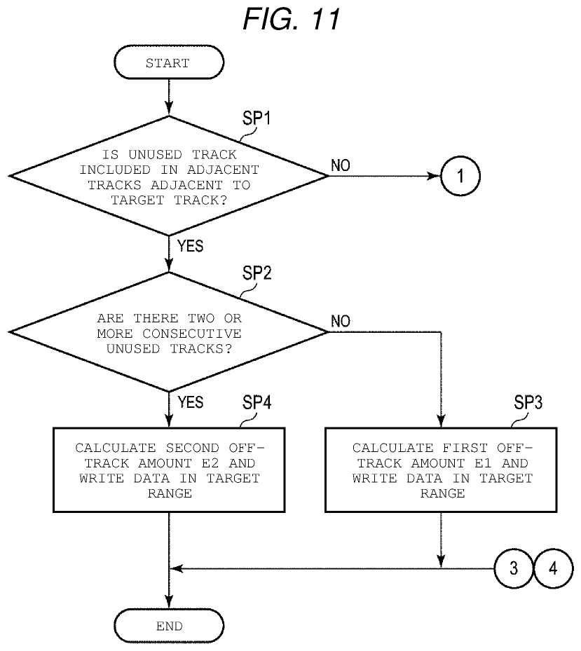

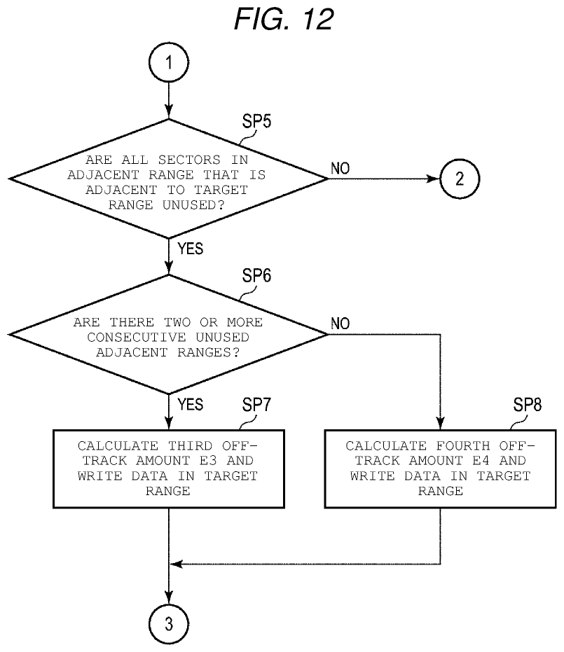

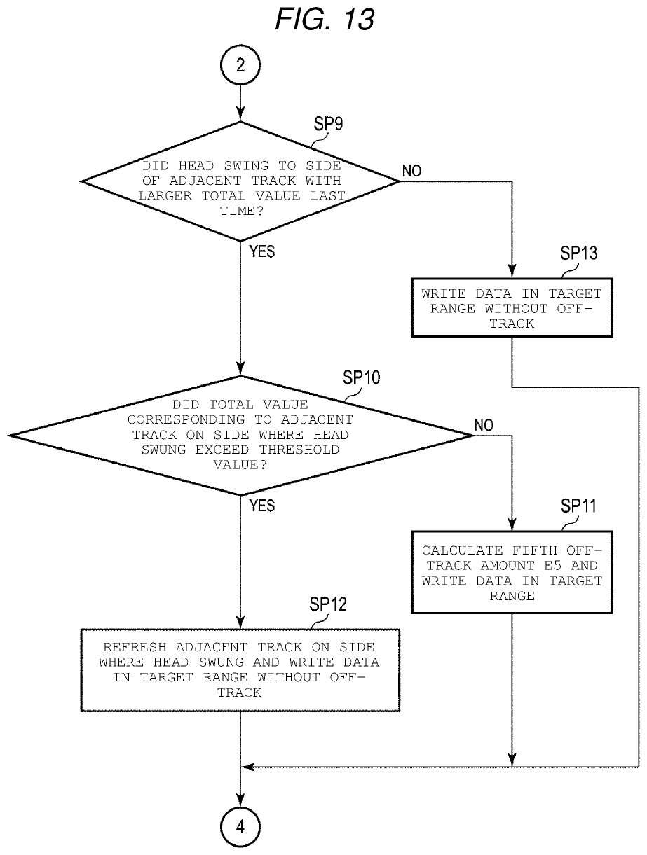

Next, the write processing method according to the present embodiment will be described together with the operation of the magnetic disk device 1. FIGS. 11, 12, and 13 are flowcharts illustrating a write processing method according to the embodiment. As illustrated in FIGS. 11, 1, and 5, when the write processing method is started, first, in step SP1, the MPU 60 determines whether adjacent tracks Tu adjacent to the target track Tt (first adjacent track Tu1 and second adjacent track Tu2) contain unused tracks. For example, use information indicating used tracks (used sectors) and unused tracks (unused sectors) is registered in advance, and when an unused track table, which can be updated at any time, is recorded in the non-volatile memory 90, the MPU 60 can determine in step SP1 based on the unused track table.

When unused tracks are provided in the first adjacent track Tu1 and the second adjacent track Tu2 (step SP1), the process proceeds to step SP2 and the MPU 60 determines whether two or more unused tracks are continuous. Here, when the first adjacent track Tu1 is an unused track, the write position can be changed to the unused first adjacent track Tu1 regardless of whether writing is performed in units of sectors or tracks.

In the example of FIG. 5, since there are no two or more continuous unused tracks (step SP2), the process proceeds to step SP3 and the MPU 60 calculates the first off-track amount E1, writes data to the target range Rt, and ends the write processing method.

On the other hand, in the example of FIG. 6, since two or more unused tracks (the first adjacent track Tu1 and the third adjacent track Tu3) are continuous (step SP2), the process proceeds to step SP4, and the MPU 60 calculates the second off-track amount E2, writes data to the target range Rt, and ends the write processing method. As described above, the MPU 60 can position the head HD more appropriately (E2>E1) by considering whether two or more unused tracks are continuous based on the unused track table.

As illustrated in FIGS. 12, 1, and 7, on the other hand, when the first adjacent track Tu1 and the second adjacent track Tu2 do not include unused tracks (step SP1), the process proceeds to step SP5, and the MPU 60 determines whether all sectors in the adjacent ranges Rd (first adjacent range Rd1 and second adjacent range Rd2) adjacent to target range Rt are unused. That is, when the first adjacent track Tu1 and the second adjacent track Tu2 are not unused tracks, the MPU 60 checks whether there is an unused range (region) in units of sectors.

In the example of FIG. 7, since all sectors in the first adjacent range Rd1 are unused (step SP5), the process proceeds to step SP6, and the MPU 60 determines whether two or more unused adjacent ranges Rd are continuous. In the example of FIG. 7, since two or more unused adjacent ranges Rd (first adjacent range Rd1 and third adjacent range Rd3) are continuous (step SP6), the process proceeds to step SP7 and the MPU 60 calculates the third off-track amount E3, writes data to the target range Rt, and ends the write processing method.

On the other hand, in the example of FIG. 8, since two or more unused adjacent ranges Rd are not continuous (step SP6), the process proceeds to step SP8 and the MPU 60 calculates the fourth off-track amount E4, and writes the data to the target range Rt, and ends the write processing method. As described above, the MPU 60 can position the head HD more appropriately (E3>E4) by considering whether two or more unused adjacent ranges are continuous based on the unused track table.

As illustrated in FIGS. 13, 1, and 9, on the other hand, when all the sectors in the first adjacent range Rd1 are not unused (step SP5), the process proceeds to step SP9, and the MPU 60 determines whether the head HD swung toward the adjacent track having a larger total value (second adjacent track Tu2) last time.

When the head HD swung toward the second adjacent track Tu2 (step SP9), the process proceeds to step SP10, and the MPU 60 determines whether the total value corresponding to the adjacent track to which the head HD swung (second adjacent track Tu2) exceeds the threshold value. In the example of FIG. 9, since the total value corresponding to the second adjacent track Tu2 does not exceed the threshold value (step SP10), the process proceeds to step SP11. The MPU 60 calculates the fifth off-track amount E5, writes data to the range Rt, and ends the write processing method.

As illustrated in FIGS. 13, 1, and 10, on the other hand, when the total value corresponding to the second adjacent track Tu2 exceeds the threshold value (step SP10), the process proceeds to step SP12, and the MPU 60 refreshes the adjacent track to which the head HD swung (second adjacent track Tu2), writes the data in the target range Rt without off-track, and ends the write processing method.

On the other hand, when the head HD did not swing toward the adjacent track having a larger total value (second adjacent track Tu2) last time (step SP9), the process proceeds to step SP13, and the MPU 60 writes data in the target range Rt without the refresh process and off-track, and ends the write processing method.

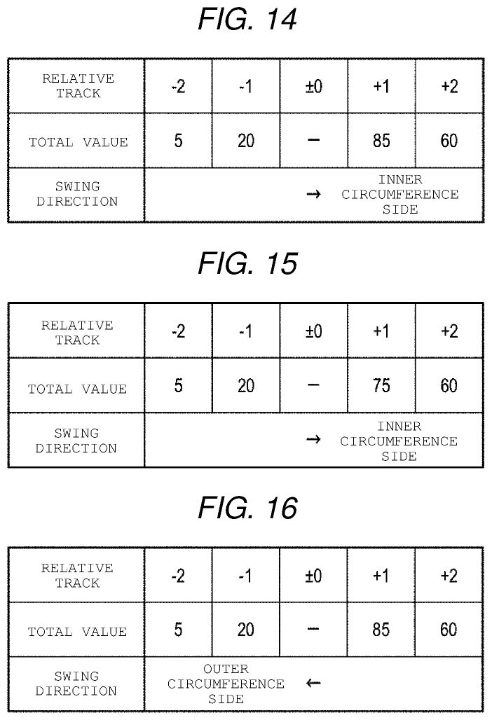

Next, the write processing method leading to step SP11, step SP12, or step SP13 will be described. FIG. 14 is a table illustrating the relationship between a relative track, a plurality of total values, and a swing direction according to Example 1 of the embodiment. FIG. 15 is a table illustrating the relationship between a relative track, a plurality of total values, and a swing direction according to Example 2 of the embodiment. FIG. 16 is a table illustrating the relationship between a relative track, a plurality of total values, and a swing direction according to Example 3 of the embodiment. The five tracks T described in FIGS. 14 to 16 are the target track Tt illustrated in FIGS. 9 and 10, the first adjacent track Tu1, the second adjacent track Tu2, the third adjacent track Tu3, and the fourth adjacent track Tu4.

As illustrated in FIG. 14, the total value of the third adjacent track Tu3 (the sum of k, which is the added value, or the sum of write count number) is “5”, and the total value of the first adjacent track Tu1 is “20”, the total value of the second adjacent track Tu2 is “85”, and the total value of the fourth adjacent track Tu4 is “60”. For example, the total value of the second adjacent track Tu2 includes the added value when data is written to the target track Tt, the added value when data is written to the fourth adjacent track Tu4, and the like.

For example, an ATI information management table is recorded in the non-volatile memory 90. ATI information indicating the correspondence relationship between the track T and the total value is registered in advance in the ATI information management table, and the MPU 60 can update the ATI information at any time.

Here, it is assumed that the total value for which read is guaranteed is 100. For example, when the total value of the second adjacent track Tu2 reaches “100”, it means that the data of the second adjacent track Tu2 is difficult to read. Therefore, for example, “80”, which is 80% of the total value (100) for which read is guaranteed, is set as the threshold value.

The total value (85) of the second adjacent track Tu2 exceeds the threshold value (80). When data was written to the target track Tt last time, the head HD swung toward the second adjacent track Tu2 having a larger total value than the first adjacent track Tu1. The MPU 60 can detect whether the head HD swung toward the inner circumference ID side or toward the outer circumference OD side for each servo region SV. Here, the MPU 60 can detect the swing direction and the swing amount of the head HD and use the detected information to calculate the fifth off-track amount E5.

From the above, the MPU 60 refreshes the second adjacent track Tu2 and resets the total value corresponding to the second adjacent track Tu2 to 0. After that, the MPU 60 writes the data to the target track Tt at the normal position.

By determining that the total value corresponding to the second adjacent track Tu2 exceeds the threshold value, the MPU 60 can detect that the second adjacent track Tu2 is a track with a high read error risk and can perform the refresh process on the second adjacent track Tu2.

As illustrated in FIG. 15, the total value of the third adjacent track Tu3 is “5”, the total value of the first adjacent track Tu1 is “20”, the total value of the second adjacent track Tu2 is “75”, and the total value of the fourth adjacent track Tu4 is “60”.

The total value (75) of the second adjacent track Tu2 does not exceed the threshold value (80). When data was written to the target track Tt last time, the head HD swung toward the second adjacent track Tu2 having a larger total value than the first adjacent track Tu1. Therefore, the MPU 60 calculates the fifth off-track amount E5, moves the head HD toward the first adjacent track Tu1 to obtain the fifth off-track amount E5, and writes data to the target track Tt. Thereby, the MPU 60 can reduce an increase in the total value corresponding to the second adjacent track Tu2.

When writing data to the target track Tt using the fifth off-track amount E5, as described above, one of the conditions is that the head HD swings toward another adjacent track Tu having a larger total value (for example, the second adjacent track Tu2) than the adjacent track Tu (for example, the first adjacent track Tu1).

However, only when the total value corresponding to the other adjacent track Tu (for example, the second adjacent track Tu2) is X times or more the total value corresponding to the adjacent track Tu (for example, the first adjacent track Tu1), data may be written to the target track Tt using the fifth off-track amount E5. Write processing methods can incorporate such restrictions as desired. When the total value corresponding to the other adjacent track Tu (for example, the second adjacent track Tu2) is less than X times the total value corresponding to the adjacent track Tu (for example, the first adjacent track Tu1), data may be normally written to the target track Tt without off-tracking. X is a numerical value exceeding 1 (X>1).

For example, assuming that X=2, the total value “75” of the second adjacent track Tu2 is more than two times (X times) the total value “20” of the first adjacent track Tu1. Data can be written to the target track Tt by moving the head HD toward the first adjacent track Tu1 side to obtain the fifth off-track amount E5. Thereby, the MPU 60 can prevent an increase in the total value of the second adjacent track Tu2.

On the other hand, assuming that X=2 and changing the total value of the second adjacent track Tu2 to “25”, the total value of the second adjacent track Tu2 “25” becomes less than two times (X times) the total value of the first adjacent track Tu1 “20”. Data can normally be written to the target track Tt without off-tracking. As a result, the total value of the first adjacent track Tu1 and the total value of the second adjacent track Tu2 can be increased evenly, that is, an excessive increase in the total value of the first adjacent track Tu1 can be prevented.

As described above, even when the head HD swings toward the second adjacent track Tu2 having a relatively large total value, data can be normally written to the target track Tt as in the case of FIG. 16, which will be described later.

As illustrated in FIG. 16, the total value of the third adjacent track Tu3 is “5”, the total value of the first adjacent track Tu1 is “20”, the total value of the second adjacent track Tu2 is “85”, and the total value of the fourth adjacent track Tu4 is “60”. When data was written to the target track Tt last time, the head HD did not swing toward the second adjacent track Tu2 having a relatively large total value. In summary, the adjacent track Tu side having a relatively large total value does not match the side to which the head HD swung. Therefore, the MPU 60 moves the head HD to the normal position without off-track and normally writes data to the target track Tt.

Next, k (k1 and k2), which is the added value adjusted by the adjustment unit 63, will be described. As shown in FIGS. 1 and 5, the added value k has a first added value k1 and a second added value k2. When data is written to the target track Tt, the counter 64 counts the write count number of the first adjacent track Tu1 as k1 and counts the write count number of the second adjacent track Tu2 as k2. Here, it is assumed that v is a coefficient, E is the off-track amount, and Q is the swing amount of the head HD.

Then,

$$\begin{matrix}v \geq 1. , \\ k 1 = {v}^{∧} ( α1 \times E + β1 \times Q ) , \\ k 2 = {v}^{∧} ( α2 \times E + β2 \times Q ) . \\ α1 , β1 , α2 , and β2 are + 1 or - 1 ,\end{matrix}$$

respectively.

Specifically, when data is written to the target track Tt by shifting the center N of the head HD from the center of the target track Tt (track center C) toward the first adjacent track Tu1, α1=+1 and α2=−1.

When data is written to the target track Tt by shifting the center N of the head HD from the center of the target track Tt (track center C) toward the second adjacent track Tu2, α1=−1 and α2=+1.

When the head HD swings toward the first adjacent track Tu1 side when data is written to the target track Tt, β1=+1 and β2=−1.

When the head HD swings toward the second adjacent track Tu2 side when data is written to the target track Tt, β1=−1 and β2=+1.

Next, k (k3 and k4), which is the added value adjusted by the adjustment unit 63, will be described. As shown in FIGS. 1 and 5, the added value k has a third added value k3 and a fourth added value k4. When data is written to the target track Tt, the counter 64 counts the write count number of the third adjacent track Tu3 as k3 and counts the write count number of the fourth adjacent track Tu4 as k4. Here, it is assumed that w is a coefficient.

Then,

$$\begin{matrix}0 < w < 1 , \\ k 3 = w \times k 1 , and \\ k 4 = w \times k 2.\end{matrix}$$

Next, the configuration of a magnetic disk device of a comparative example and the effects of the above embodiment will be described in order. First, the magnetic disk device of the comparative example will be described.

In the magnetic disk device, data patterns on adjacent tracks are deteriorated by ATI influence, increasing the risk of read errors. To prevent or reduce read errors, disks are refreshed. Here, the value of the counter addition amount is calculated considering drift off write (DOW) influence. The counter adds an amount according to the off-track write (swing amount) from the center of the adjacent write target track, which changes each time a write is performed. When the amount of addition per write is large, it leads to frequent refresh processing operations, which is one of the causes of performance deterioration of the magnetic disk device.

A mechanism for managing the ATI count and write offset amount for each track and calculating a value to be added to adjacent tracks according to the write offset amount is applied to the magnetic disk device. However, in the magnetic disk device of the comparative example, the write processing unit does not perform the write processing based on the track use information.

On the other hand, according to the magnetic disk device 1 and the write processing method according to the present embodiment configured as described above, the write processing unit 61a can perform write processing based on the use information of a plurality of tracks T. The MPU 60 can detect adjacent tracks (or adjacent sectors) in which the ATI influence can be relatively tolerated, and bring the data write position closer to the detected adjacent track (or adjacent sector) side. Then, the ATI influence on adjacent tracks (or adjacent sectors) on the opposite side can be mitigated. Here, the added value k for the adjacent track closer to the data write position is increased, but the added value k for the adjacent track on the opposite side is subtracted by the swing amount. Since the frequency of the refresh process can be reduced, the performance of the magnetic disk device 1 can be improved.

Whether the first adjacent track Tu1 and the second adjacent track Tu2 on both sides of the target track Tt are unused tracks, whether unused sectors remain in the first adjacent track Tu1 and the second adjacent track Tu2, whether the side of the adjacent track Tu having a relatively large total value match the side to which the head HD swings, or whether there is a margin between the per-track total values and the guaranteed total values (whether the per-track total values exceed the threshold value) can be checked from the unused track table, the servo information, and the ATI information management table. As a result, the off-track amount E can be calculated and data can be written using the off-track amount E. From the above, it is possible to obtain a magnetic disk device 1 and a write processing method that can rewrite data efficiently.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

For example, the technique described above may be applied to a shingled write recording type magnetic disk device and a hybrid recording type magnetic disk device that selects and executes the conventional magnetic recording type and the shingled write recording type. For example, in the hybrid recording type, the user data region U of the recording layer Y has a shingled write recording region on the inner circumference side and a conventional magnetic recording region on the outer circumference side of the shingled write recording region. The conventional magnetic recording region is sometimes called a conventional zone, and can be a region in which frequently rewritten data such as system files and metadata are recorded.

What is claimed is:

1. A magnetic disk device comprising:
a disk including, on a recording layer, a target track, first and second adjacent tracks that are adjacent to the target track and are respectively on either side of the target track in a radial direction;
a head configured to write data to the recording layer of the disk; and
a control circuit configured to:
when data is written in a target range of the target track, calculate an off-track amount based on the use information indicating use states of each of the first adjacent track and the second adjacent track, position the head according to the calculated off-track amount, and write data in the target range with the head positioned according to the calculated off-track amount.

2. The magnetic disk device according to claim 1, wherein
the disk further includes a third adjacent track adjacent to the first adjacent track in the radial direction and sandwiching the first adjacent track together with the target track in the radial direction, and a fourth adjacent track adjacent to the second adjacent track in the radial direction and sandwiching the second adjacent track together with the target track in the radial direction, and
the control circuit is configured to calculate the off-track amount based on the use information indicating use states of each of the first, second, third, and fourth adjacent tracks.

3. The magnetic disk device according to claim 2, wherein
when writing data to the target range of the target track and the use information indicates that the first adjacent track is entirely unused, the second adjacent track contains used sectors, and the third adjacent track contains used sectors, the control circuit calculates a first off-track amount, which is an amount by which the center of the head is to be shifted from the center of the target track toward the first adjacent track side, based on the use information, positions the head according to the first off-track amount, and writes data in the target range with the head positioned according to the first off-track amount.

4. The magnetic disk device according to claim 3, wherein
when writing data to the target range of the target track and the use information indicates that the first adjacent track is entirely unused, the third adjacent track is entirely unused, and the second adjacent track contains used sectors, the control circuit calculates a second off-track amount, which is an amount by which the center of the head is to be shifted from the center of the target track toward the first adjacent track side, based on the use information, positions the head according to the second off-track amount, and writes data in the target range with the head positioned according to the second off-track amount.

5. The magnetic disk device according to claim 4, wherein the first off-track amount is less than the second off-track amount.

6. The magnetic disk device according to claim 3, wherein
when writing data to the target range of the target track and the use information indicates that all sectors within the first adjacent track that are in a first adjacent range adjacent to the target range are unused, the first adjacent track contains used sectors other than the sectors in the first adjacent range, all sectors within a third adjacent range that are adjacent to the first adjacent range are unused, and some sectors of the second adjacent track that are in a second adjacent range adjacent to the target range are used sectors, the control circuit calculates a third off-track amount, which is an amount by which the center of the head is to be shifted from the center of the target track toward the first adjacent track side, based on the use information, positions the head according to the third off-track amount, and writes data in the target range with the head positioned according to the third off-track amount.

7. The magnetic disk device according to claim 6, wherein the first off-track amount is greater than or equal to the third off-track amount.

8. The magnetic disk device according to claim 7, wherein
when writing data to the target range of the target track and the use information indicates that all the sectors in the first adjacent range are unused, the first adjacent track contains used sectors other than the sectors in the first adjacent range, some sectors in the third adjacent range are used sectors, and some sectors in the second adjacent range are used sectors, the control circuit calculates a fourth off-track amount, which is an amount by which the center of the head is to be shifted from the center of the target track toward the first adjacent track side, based on the use information, positions the head according to the fourth off-track amount, and writes data in the target range with the head positioned according to the fourth off-track amount.

9. The magnetic disk device according to claim 8, wherein the fourth off-track amount is less than the third off-track amount.

10. The magnetic disk device according to claim 9, further comprising:
a storage unit in which the control circuit stores a plurality of total values, each of which corresponds to one of a plurality of tracks of the recording layer and represents a cumulative effect of adjacent track interference from data previously written to other tracks, wherein
the control circuit is further configured to detect a swing direction and a swing amount of the head when data is written to a predetermined track and update the total value of each track that is located in a periphery of the predetermined track based on the swing direction and the swing amount, and
when writing data to the target range of the target track and the use information indicates that the first adjacent range contains used sectors and the second adjacent range contains used sectors, the control circuit performs a refresh processing or calculates a fifth off-track amount, which is an amount by which the center of the head is to be shifted from the center of the target track toward the first adjacent track side, based on the plurality of total values stored in the storage unit and the swing direction of the head when data was last written to the target track, positions the head according to the fifth off-track amount, and writes data in the target range with the head positioned according to the fifth off-track amount.

11. The magnetic disk device according to claim 10, wherein the fifth off-track amount is less than the fourth off-track amount.

12. The magnetic disk device according to claim 11, wherein
the fifth off-track amount is zero when the second adjacent track has a total value that is larger than that of the first adjacent track and the head did not swing toward the second adjacent track during the last write to the target track.

13. The magnetic disk device according to claim 11, wherein
the fifth off-track amount is greater than zero when the second adjacent track has a total value that is larger than that of the first adjacent track but smaller than a threshold value and the head swung toward the second adjacent track during the last write to the target track.

14. The magnetic disk device according to claim 11, wherein
the control circuit is further configured to perform a refresh processing on the second adjacent track when the second adjacent track has a total value that is larger than that of the first adjacent track and larger than a threshold value and the head swung toward the second adjacent track during the last write to the target track.

15. A write processing method applied to a magnetic disk device including a disk including on a recording layer, a target track, first and second adjacent tracks that are adjacent to the target track and are respectively on either side of the target track in a radial direction, and a head configured to write data to the recording layer of the disk, the method comprising:
determining use states of the first adjacent track and the second adjacent track;
calculating an off-track amount based on the use states;
positioning the head according to the calculated off-track amount; and
writing data to a target range of the target track with the head positioned according to the calculated off-track amount.

16. The method according to claim 15, further comprising:
storing in a non-volatile memory a plurality of total values, each of which corresponds to one of a plurality of tracks of the recording layer and represents a cumulative effect of adjacent track interference from data previously written to other tracks; and
when data is written to a predetermined track, detecting a swing direction and a swing amount of the head and updating the total value of each track that is located in a periphery of the predetermined track based on the swing direction and the swing amount.

17. The method according to claim 16, further comprising:
when writing data to the target range of the target track and the use information indicates that some sectors within the first adjacent track that are in a first adjacent range adjacent to the target range are used sectors, and some sectors of the second adjacent track that are in a second adjacent range adjacent to the target range are used sectors, performing a refresh processing or calculating the off-track amount based on the plurality of total values stored in the storage unit and the swing direction of the head when data was last written to the target track.

18. The method according to claim 17, wherein
the off-track amount is zero when the second adjacent track has a total value that is larger than that of the first adjacent track and the head did not swing toward the second adjacent track during the last write to the target track.

19. The method according to claim 17, wherein
the off-track amount is greater than zero when the second adjacent track has a total value that is larger than that of the first adjacent track but smaller than a threshold value and the head swung toward the second adjacent track during the last write to the target track.

20. The method according to claim 17, wherein
the refresh processing is performed on the second adjacent track when the second adjacent track has a total value that is larger than that of the first adjacent track and larger than a threshold value and the head swung toward the second adjacent track during the last write to the target track.
